(19) United States
(12) Patent Application Publication
(10) Pub. No.: US 2010/0071523 A1
(43) Pub. Date: Mar. 25, 2010

(54) Stud cutter

(76) Inventor: Martin M. Daniels, Milford, MI (US)

Correspondence Address: John G. Chupa;Law Offices of John Chupa and Associates, P.C., Suite 50, 28535 Orchard Lake Rd., Farmington Hills, MI, 48334, US

(21) Appl. No.: 12/284,222

(22) Filed: Sep. 20, 2008

(51) Int. Cl. B26D 7/02

(52) U.S. Cl. 83/454

(57) ABSTRACT

A stud cutter 10 which is adapted to selectively and efficiently cut a metal stud and which includes stationary blade and selectively movable blades 100, 102 which cooperatively cut the stud.

### FIELD OF THE INVENTION

The present invention generally relates to a stud cutter and more particularly to a cutter which efficiently and easily cuts a metal stud member.

### BACKGROUND OF THE INVENTION

Metal stud members are used to construct walls and other portions of buildings and various structures. While these members provide significant structural advantages over wood and other members, they are relatively difficult to cut or sever.

Oftentimes, these metal stud members are cut or severed by the use of a relatively costly and noisy apparatus which may undesirably produce sparks and other undesirable by-products (e.g., airborne metal particulates) which may be hazardous to one's health and which may create relatively serious environmental difficulties.

To overcome the foregoing drawbacks of the previously described stud cutting strategy, Applicant has invented the stud cutter which is described within U.S. Pat. No. 7,219,586 (“the '586 patent”), which was issued on May 22, 2207, which is owned by Applicant, and which is fully and completely incorporated herein by reference, word for word and paragraph for paragraph. While the stud cutter of the '586 patent does desirably overcome many of the disadvantages associated with prior stud cutting strategies, the stud cutter of the present Application provides even enhanced capability and functionality as will be apparent from a reading of the detailed description of the preferred embodiment of the invention.

### SUMMARY OF THE INVENTION

It is a first non-limiting object of the present invention to provide a stud cutter which overcomes the disadvantages of prior cutters and cutting strategies.

It is a second non-limiting object of the present invention to provide a stud cutter which efficiently and easily allows for a metal stud to be cut.

According to a first non-limiting aspect of the present invention, a stud cutter is provided and includes a base portion which is adapted to be selectively and operatively placed upon a certain surface; a first blade which is fixedly attached to the base portion and which includes a cutting edge; a pair of blades which are each movably attached to the base portion and which are each selectively movable only in opposite directions toward and away from the first blade; a stud guide portion which is removably attached to a first side of the base portion, which includes a stud reception surface which is coplanar to the cutting edge, and which includes a foot which is adapted to rest upon the certain surface; a second foot which is attached to a second side of the base portion and which is dissimilar to the first foot, the second foot begin adapted to rest upon the certain surface and cooperate with the first foot to reduce movement of the base portion in a direction perpendicular to the cutting edge; and a handle which is attached to the second and third blades and which allows the second and third blades to respectively and concomitantly move in the first and second directions, thereby causing the second and third blades to cooperate with the first blade to selectively cut a stud member.

According to a second non-limiting aspect of the present invention, a cutter is provided and includes a base member including a notch portion which contains a material of a relatively high coefficient of friction; a pair of substantially identical and selectively movable blades which are concomitantly movable from a first respective open position to a second respective closed position, wherein the pair of blades are respectively attached to opposite side surfaces of the base member; a third stationary blade portion which protrudes from the base member and which is positioned between the pair of substantially identical and selectively movable blades; a stud guide portion which includes a pair of substantially identical projections which are adapted to be selectively and removably placed within apertures formed within said base portion, effective to allow the stud guide portion to orthogonally project away from the base portion in a first direction; a second member which orthogonally projects from the base portion in a second direction which is opposite to the first direction, wherein the stud guide portion and the second member cooperate to provide lateral stabilization to the base portion; and a handle portion which is coupled to the pair of blade and which selectively moves the blades from the respective first position to the respective second position, thereby allowing the pair of blades to cooperate with the third blade to selectively cut a stud member.

According to a third non-limiting aspect of the present invention, a stud cutter is provided and includes a base member having a body portion which lies along a certain axis and which includes a second portion which forms an acute angle with the body portion, the body portion further including a notch having a high coefficient of friction, wherein the body portion further including a plate which is coupled to a first surface of the body portion and which has a sharp cutting edge disposed a certain height above the body portion and lying in an axis which is parallel to said certain axis; a first and a second blade which are respectively and movably attached to the body portion and which each respectively include a cutting portion which is respectively positioned above the sharp cutting edge and which are respectively movable towards and away from the sharp cutting edge; a stud guide member which is selectively attached to the plate and which has a stud support surface which is co-planar with the sharp cutting edge and which also has a foot portion which cooperates with and which orthogonally projects from the stud support surface to provide lateral support to the first surface of said body portion; a second foot portion which is coupled to a second surface of the body portion and which provides lateral support to the second surface of the body portion, wherein the second surface is an opposite surface to the first surface; a handle assembly which is coupled to the first and second blades and which causes the first and second blades to only concomitantly move, effective to cooperate with the sharp cutting edge to selectively cut a stud.

These and other features, aspects, and advantages of the present invention will become apparent from a reading of the detailed description of the preferred embodiment of the invention, including the subjoined claims, and by reference to the included drawings.

### BRIEF DESCRIPTION OF THE DRAWINGS

FIG. 1 is a perspective view of the stud cutter which is made in accordance with the teachings of the preferred embodiment of the invention and which is shown in a selected open position and which also shows, in phantom, an alternate grip placement in accordance with the teachings of various inventions.

FIG. 2 is a side view of the stud cutter which is shown in FIG. 1 but further shown in a selected, closed, or cutting position.

FIG. 3 is an unassembled side view of the stud cutter which is shown in FIG. 2.

FIG. 4 is a side view of the stud cutter shown in FIG. 2 but further shown in a selected open position.

FIG. 5 is a rear perspective view of the stud butter which is shown in FIG. 4.

FIG. 6 is a partial top view of the stud cutter which is shown in FIG. 1.

### DETAILED DESCRIPTION OF THE PREFERRED EMBODIMENT OF THE INVENTION

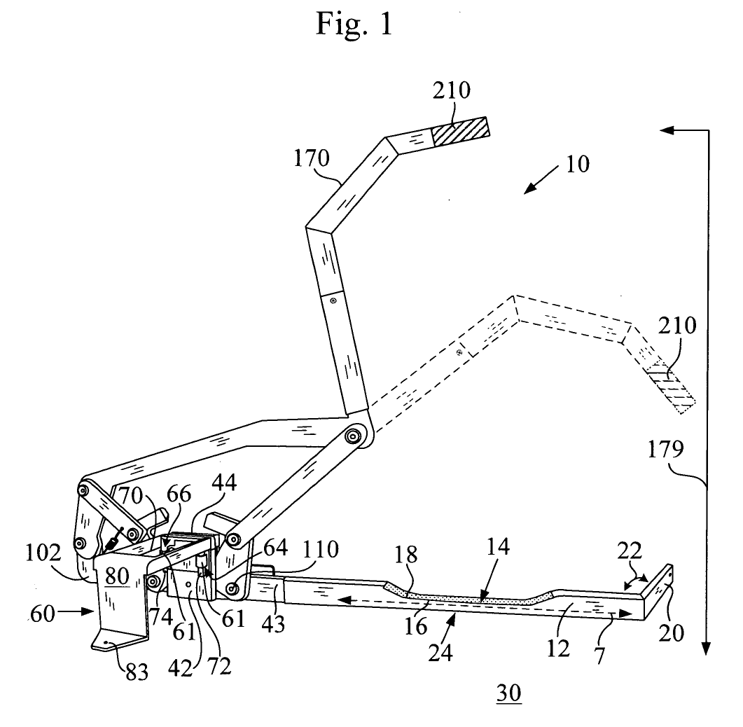

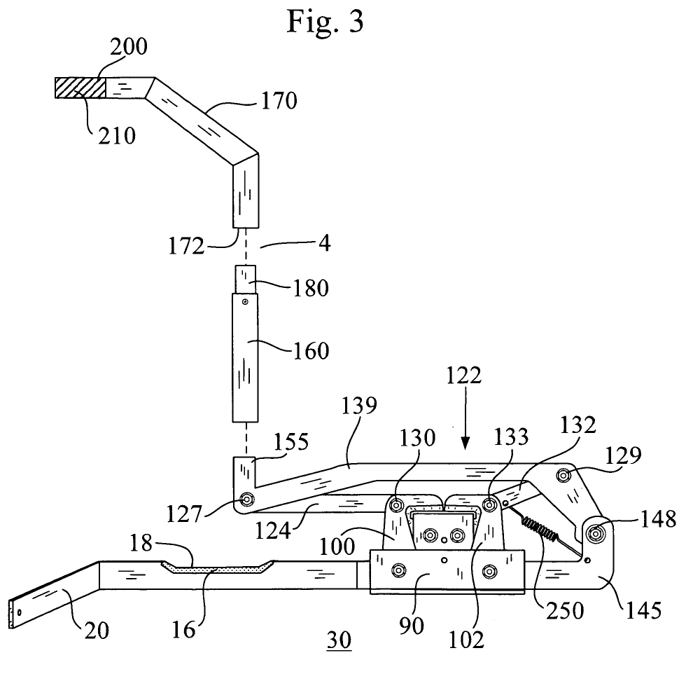

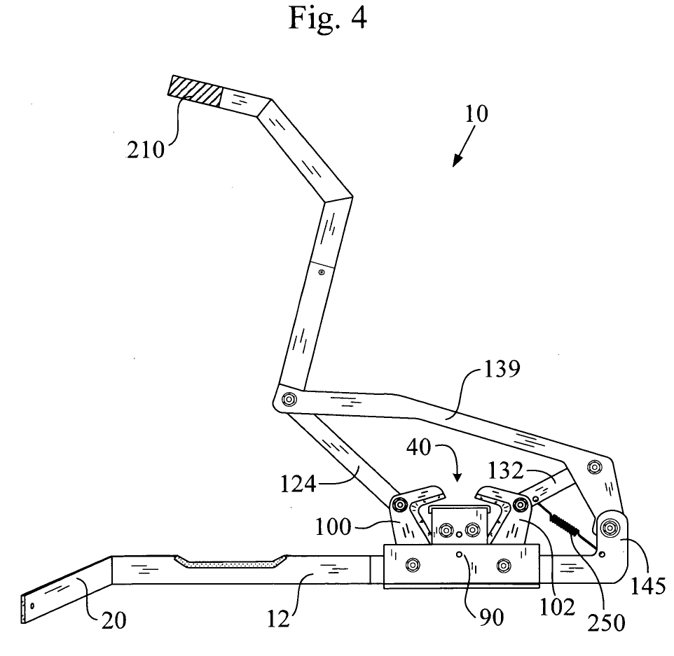

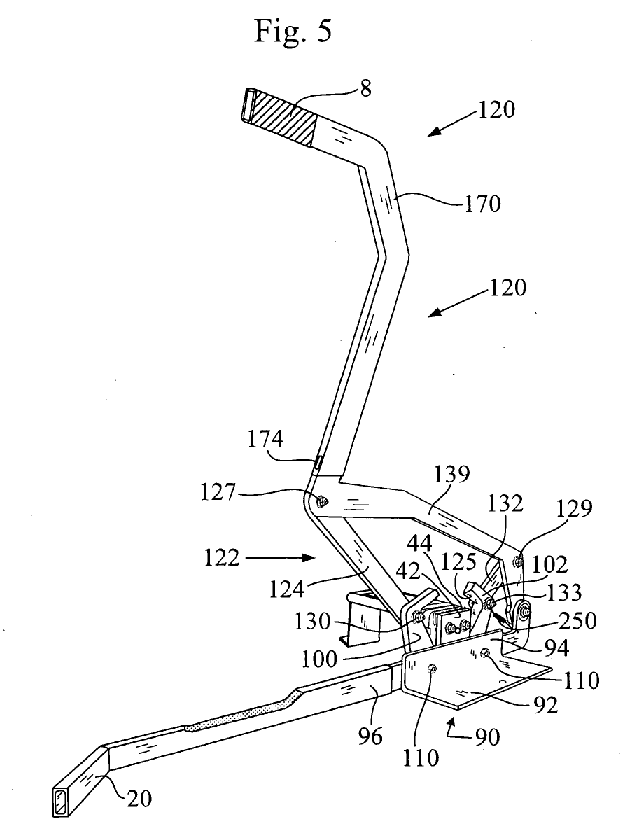

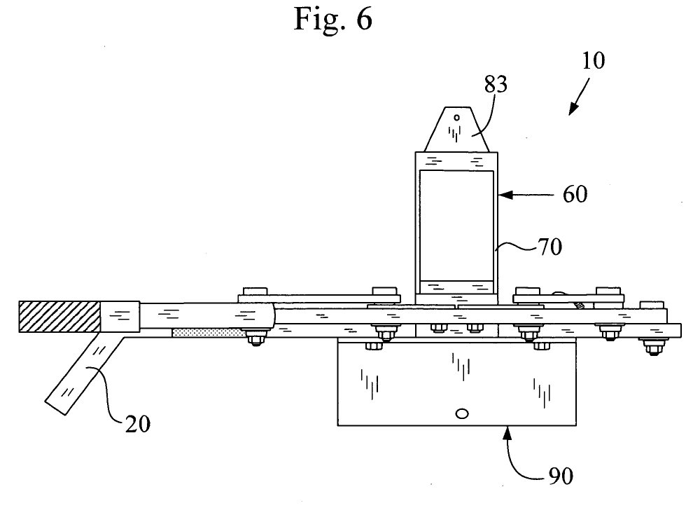

Referring now to FIGS. 1-6, there is shown a stud cutter 10 which is made in accordance with the teachings of the preferred embodiment of the invention.

Particularly, stud cutter 10 includes an elongated base portion 12 having a top notch 14 and an exposed top surface 16 having a relatively large coefficient of friction. In one non-limiting embodiment of the invention, upon the whole top surface 16 is disposed material 18 (e.g., such as commercially available rubber) which provides the desired large coefficient of friction. Further, the base portion 12 includes an angled end portion 20 which forms an acute angle 22 with respect to the body or body portion 24 of the base 12 and, as should be apparent to one of ordinary skill in the art, the angled end portion 20 provides for stable placement of the stud cutter 10 upon a desired surface 30. Surface 30 may comprise a table, floor, or substantially any other desired surface. In one non-limiting embodiment of the invention, body portion 24 lies along the axis 7. That is, axis 7 is a longitudinal axis of symmetry of the body portion 24 and angle 22 is an acute angle with respect to the axis 7.

Additionally, the stud cutter 10 further includes a first stationary blade assembly 40 comprising a plate 42 which is attached to a first surface 43 of the base portion 12 (e.g., of the body portion 24 of base portion 12) and which includes a substantially stationary sharp edge 44 which is stationarally disposed above the body portion 24 and which resides within an axis 50 which is substantially, although not entirely parallel to the surface 16, to the body portion 24, and which is parallel to the longitudinal axis of symmetry 7. The stud cutter 10 also includes a stud guide and retention portion 60 and the plate 42 includes a pair of substantially identical members 61 (e.g., in one non-limited embodiment each of the members 61 is of a “loop like” form or semi-circular form) and which are respectively disposed upon the plate 42 and which respectively cooperate with the plate 42 to form respective cavities 64, 66 or “slotted apertures” 64, 66. The portion 60 includes a pair of substantially identical protuberances 72, 74 which are respectively adapted to be selectively and removably placed within cavities or apertures 64, 66, thereby selectively and removably affixing the portion 60 to the plate 42. The portion 60 includes a substantially planar stud reception/support portion 70 which is made to be coplanar to blade 44 when the protuberances 72, 74 are made to respectively, selectively and fully reside within cavities or apertures 64, 66. The portion 70 orthonally protrudes from the plate 42 and from the body portion 12.

Further, the stud retention portion 60 includes a portion 80 which orthogonally protrudes from and terminates into portion 70 and further, at a remote end, terminates into a foot portion 83 which is adapted to rest upon the surface orthogonally 30. In this manner, it should be appreciated that the stud retention member 60 provides lateral stability or support to the stud cutter 10 (e.g., support which tends to ensure that the stud cutter 10 does not move off of surface 30 in an angular fashion toward the foot 83. Moreover, the stud cutter 10 includes a second foot member 90 having a first portion 92 which is adapted to selectively rest upon the surface 30 and a second portion 94 which orthogonally projects from and orthogonally and integrally terminates into the portion 92 and which is attached (e.g., by a welded or fastened connection) to the surface 96 of the body portion 24). The surface 96 is a surface of the body portion 24 which is opposite to surface 43). Thus, it should be appreciated that the second foot member 90 provides lateral support to the surface 96 (e.g., tends to ensure that the body 24 does not lift off of the surface 30 and tilt toward the foot 90. The feet 83 and 90 cooperate with the angled portion 20 to ensure that the stud cutter 10 remain operatively positioned upon the surface 30 in the manner which is shown for example and without limitation in FIG. 1.

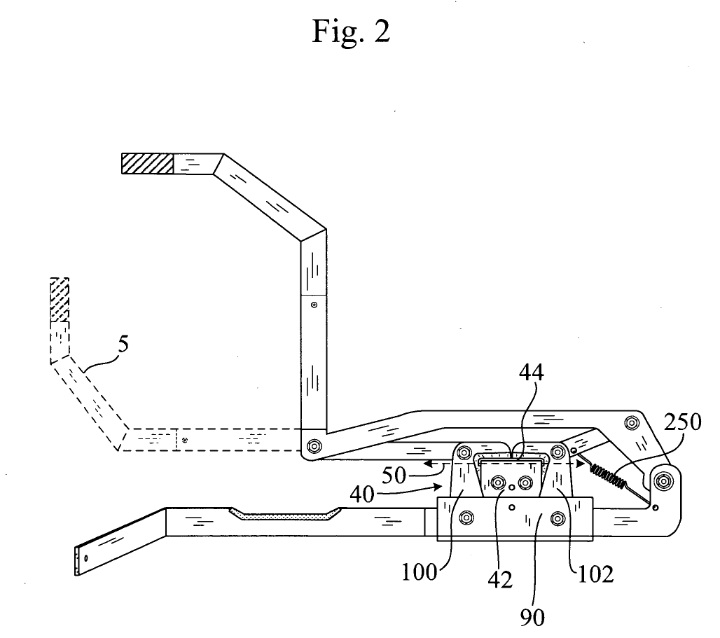

The stud cutter 10 also includes a pair of substantially identical “L-shaped” blades 100, 102 which are each coupled to the surface 96 by a respective pin or respective nut and bolt assembly 110 (which traverses the portion 94), and each blade 100, 102 is “L-shaped” and respectively includes a sharp cutting member or portion 125 and each sharp cutting member or portion 125 is made to reside proximate to a unique end of the sharp cutting blade 44. In one non-limiting embodiment, when the stud cutter 10 is selectively placed in a closed or “cutting position” (see, for example, FIG. 2), the respective portions 125 of the blades 100, 102 cooperatively and fully cover the sharp blade edge 44.

The stud cutter 10 includes a serpentine handle assembly 120 having a first cantilever assembly 122 and the cantilevered assembly 122 includes a first arm 124 which is coupled to the blade 100 by the use of pin or a nut and bolt assembly 130, and a second arm 132 which is coupled to the blade 102 by the pin or a nut and bolt assembly 133. Assembly 122 includes another arm 139 which is coupled and to a protruding end portion 145 which terminates into body 12, by the pin or a nut and bolt assembly 148, the arm 124 by pin or a nut and bolt assembly 127, and to the arm 132 by pin or a nut and bolt assembly 129. Arm 133 includes a generally cylindrical and generally hollow protuberance 155 proximate to the pin 127. The handle assembly 120 further includes a second generally cylindrical and generally hollow portion 160 which selectively receives the protuberance 155 and a grip portion 170 having a first aperture 172 and a second aperture 174. Each of the apertures 172, 174 are respectively adapted to selectively receive the telescoping end 180 of portion 160, thereby allowing the grip portion 170 to be positioned in a desired manner. The end 200 of the grip portion 170 may have a portion 210 with a relatively large coefficient of friction (e.g., made of rubber type material 8). As shown best in FIG. 1, the position of grip portion 170 varies depending upon which aperture 172, 174 is made to selectively receive the portion 180 (e.g., the height 179 from surface 30 may be adjusted for convenience purposes). That is, if aperture 174 is made to receive the portion 180 then the height 179 is lower than if the aperture 172 is made to receive the portion 180.

It should be appreciated that the handle assembly 120 allows for the blades 100, 102 to move only in a concomitant manner towards and way from the sharp edge 44 (e.g., in a selective and reciprocal manner). Thus, in operation, a metal stud may be placed upon the portion 70 (over blade 44). The handle assembly 120 is then moved downwards (in the direction of surface 30) and the blades 100, 102 cooperate with blade 44 to cut or sever the stud (e.g., the portion 170 moves arm 139 toward surface 30 which causes arms 124, 132 to force blades 100, 102 against edge 42). The handle assembly 120 is then selectively moved upwards (away from surface 30) causing the arms 132, 124, 139 and blades 100, 102 to move in an opposite direction) and the cut stud may be removed from the portion 70. In one non-limiting embodiment of the invention, a spring 250 may be provided and coupled to arm 132, and to end 145, to bias the cantilever assembly 122 in an open position in order to reduce the likelihood of accidental cutting or accidental downward movement of the blades 100, 102. It should further be appreciated that the blades 100, 102 and edge 44 may be covered with Titanium and that the grip portion 170 and portion 160 may be easily removed and later assembled for relatively easy shipping. Further, material 18 allows for the safe/“slip fee” placement of a user's foot to accommodate use and the portion 210 (i.e., material 8) allows for a “sure grip” with which to move the handle assembly 120.

It is to be understood that the invention is not limited to the exact construction or methodology which has been described above, but that various changes and modifications may be made without departing from the spirit and the scope of the inventions as are more fully described in the following claims.

What is claimed is:

1) A stud cutter having a base portion which is adapted to be selectively and operatively placed upon a certain surface; a first blade which is fixedly attached to said base portion and which includes a cutting edge; a pair of blades which are each movably attached to said base portion and which are each selectively movable only in opposite directions toward and away from said first blade; a stud guide portion which is removably attached to a first side of said base portion, which includes a stud reception surface which is coplanar to said cutting edge, and which includes a foot which is adapted to rest upon said certain surface; a second foot which is attached to a second side of said base portion and which is dissimilar to said first foot, said second foot being adapted to rest upon said certain surface and cooperate with said first foot to reduce movement of said base portion in a direction perpendicular to said cutting edge; and a handle which is attached to said second and third blades and which allows said second and third blades to respectively and concomitantly move in said first and second directions, thereby causing said second and third blades to cooperate with said first blade to selectively cut a stud member.

2) The stud cutter of claim 1 wherein said second and third blades are substantially identical.

3) The stud cutter of claim 2 wherein said handle is of a serpentine shape.

4) The stud cutter of claim 3 wherein said base portion further includes a notch having an exposed surface having a relatively high coefficient of friction.

5) The stud cutter of claim 4 wherein said serpentine handle has a portion having a relatively high coefficient of friction.

6) The stud cutter of claim 5 wherein each of said second and third blades are “L-shaped”.

7) The stud cutter of claim 6 wherein said handle portion has a first portion which is coupled to said second and third blades; and a second portion which is selectively attachable to said first portion at a first and a second surface.

8) A cutter comprising a base member including a notch portion which contains a material of a relatively high coefficient of friction; a pair of substantially identical and selectively movable blades which are concomitantly movable from a first respective open position to a second respective closed position, wherein said pair of blades are respectively attached to opposite side surfaces of said base member; a third stationary blade portion protrudes from said base member and which is positioned between said pair of substantially identical and selectively movable blades; a stud guide portion including a pair of substantially identical projections which are adapted to be selectively and removably placed within apertures formed within said base portion, effective to allow said stud guide portion to orthogonally project away from said base portion in a first direction; a second member which orthogonally projects from said base portion in a second direction which is opposite to said first direction, wherein said stud guide portion and said second member cooperate to provide lateral stabilization to said base portion; and a handle portion which is coupled to said pair of blade and which selectively moves said blades from said respective first position to said respective second position, thereby allowing said pair of blades to cooperate with said third blade to selectively cut a stud member.

9) The cutter of claim 8 wherein said base member includes a first portion which lies along a first axis and a second portion which forms an acute angle with said first portion.

10) A stud cutter comprising a base member having a body portion which lies along a certain axis and which includes a second portion which forms an acute angle with said body portion, said body portion further including a notch having a high coefficient of friction, wherein said body portion further including a plate which is coupled to a first surface of said body portion and which has a sharp cutting edge disposed a certain height above said body portion and lying in an axis which is parallel to said certain axis; a first and a second blade which are respectively and movably attached to said body portion and which each respectively include a cutting portion which is respectively positioned above said sharp cutting edge and which are respectively movable towards and away from said sharp cutting edge; a stud guide member which is selectively attached to said plate and which has a stud support surface which is co-planar with said sharp cutting edge and which also has a foot portion which cooperates with orthogonally projects from said stud support surface to provide lateral support to said first surface of said body portion; a second foot portion which is coupled to a second surface of said body portion and which provides lateral support to said second surface of said body portion, wherein said second surface is an opposite surface to said first surface; a handle assembly which is coupled to said first and second blades and which causes said first and second blades to only concomitantly move, effective to cooperate with said sharp cutting edge to selectively cut a stud.

11) The stud cutter of claim 10 wherein said handle assembly has a first portion with a protuberance; and a second portion having a pair of slotted apertures which are each adapted to selectively and securely receive said protuberance, effective to allow said second portion to be connected to said first portion by use of a selected one of said pair of slotted apertures.

12) The stud cutter,of claim 11 wherein said pair of slotted apertures are disposed upon a first end of said second portion and wherein said second portion includes a second end which is opposite to said first end and upon which is disposed material with a high coefficient of friction.

13) The stud cutter of claim 12 wherein said first and second blades are each coated with Titanium material.

14) The stud cutter of claim 13 wherein said first and second blades are L-shaped.

15) The stud cutter of claim 14 wherein said second foot portion has a first surface which is coupled to said body portion and which has an outer edge which is parallel to said certain axis and which lies below said sharp cutting edge; and a second surface which orthogonally projects from said first surface and which lies in a plane which is parallel to the plane in which said stud guide portion operatively resides.
